(19) United States
(12) Patent Application Publication
(10) Pub. No.: US 2013/0162975 A1
(43) Pub. Date: Jun. 27, 2013

(54) FAN ROTATION SPEED DETECTION SYSTEM

(71) Applicants: ZHI-YONG GAO, Wuhan City (CN); HAI-YI JI, Wuhan City (CN); YU-LIN LIU, Wuhan City (CN)

(72) Inventors: ZHI-YONG GAO, Wuhan City (CN); HAI-YI JI, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/592,605

(22) Filed: Aug. 23, 2012

(30) Foreign Application Priority Data
Dec. 27, 2011 (CN) 201110443670.7

(51) Int. Cl. G01P 3/40

(52) U.S. Cl. 356/28

(57) ABSTRACT

A fan rotation speed detection system includes a sampling and modulating unit, a lighting unit, a light sensing unit, a demodulating unit, and a control chip. The sampling and modulating unit generates a sampling frequency signal. The sampling frequency signal is a square wave signal. The lighting unit emits light on fan blades of a fan when the square wave signal is at a high level. The light sensing unit senses light reflected from the fan blades and generate a detection signal. The demodulating unit demodulates the detection signal to generate a demodulated signal when the square wave signal is at a high level. The control chip accounts a rotation speed of the fan according to the demodulated signal.

### BACKGROUND

1. Technical Field

The present disclosure relates to detection systems, especially to a detection system for detecting fan rotation speeds.

2. Description of Related Art

After computers are manufactured, quality tests are required. One of the tests is to detect the rotation speed of the fans of the computers. A conventional method to detect the rotation speed of the fans is using a stroboscope. However, environment light may interfere with the stroboscope, which lowers detection accuracy.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a fan rotation speed detection system.

FIG. 2 is one embodiment of a circuit of the fan rotation speed detection circuit shown in FIG. 1.

FIG. 3 is a waveform of signals of the fan rotation speed detection system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

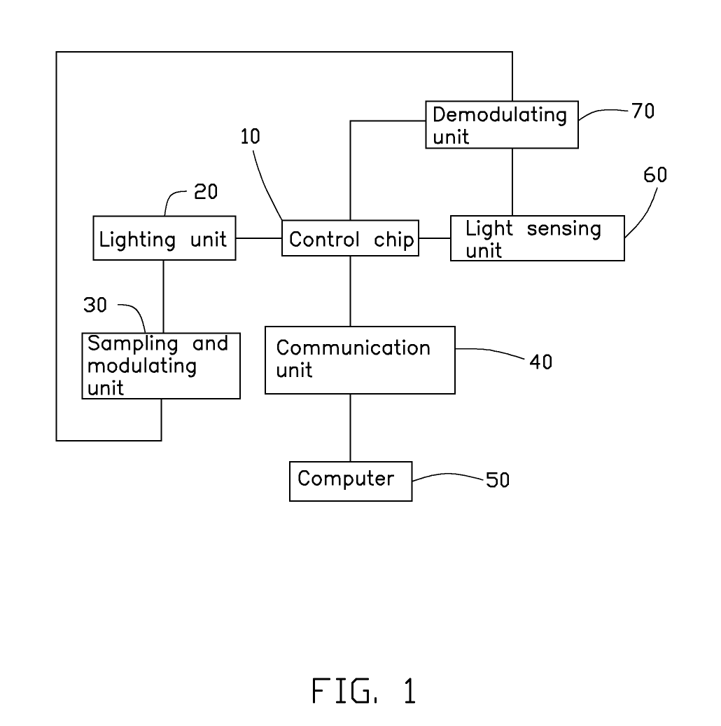

Referring to FIG. 1, an embodiment of a fan rotation speed detection system includes a control chip 10, a lighting unit 20, a sampling and modulating unit 30, a communication unit 40, a computer 50, a light sensing unit 60, and a demodulating unit 70. The control chip 10 is connected to the lighting unit 20, the communication unit 40, the light sensing unit 60, and the demodulating unit 70. The sampling and modulating unit 30 is connected to the lighting unit 20 and the demodulating unit 70. The computer 50 is connected to the communication unit 40.

The lighting unit 20 is configured to emit light to fan blades of a fan (not shown). A plurality of light reflecting material is coated on the fan blades. The fan blades reflect light to the light sensing unit 60. The light sensing unit 60 counts according to the reflected light.

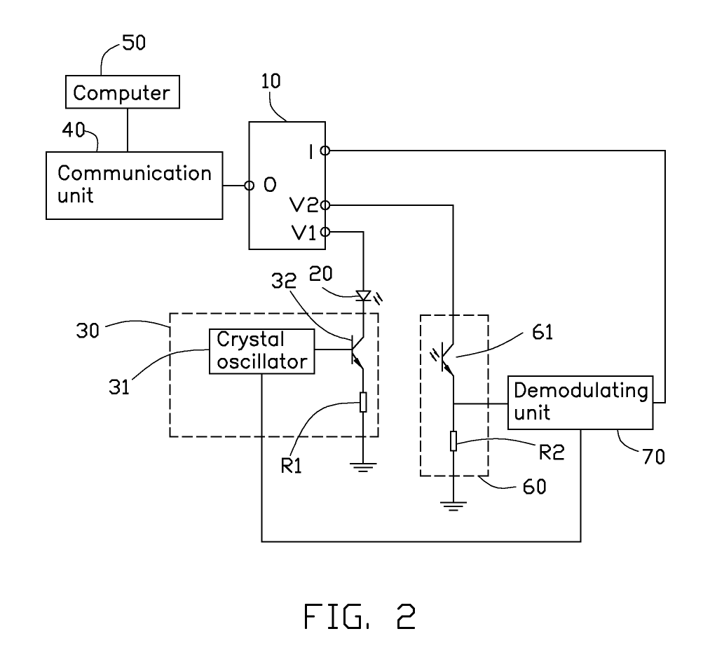

Referring to FIG. 2, the control chip 10 includes a signal input pin I, a signal output pin O, a first voltage output pin V1, and a second voltage output pin V2. In one embodiment, the lighting unit 20 is a light-emitting diode. The light-emitting diode 20 includes a diode anode and a diode cathode. The first voltage output pin V1 is connected to the diode anode of the light-emitting diode 20. The sampling and modulating unit 30 includes a crystal oscillator 31 and a NPN transistor 32. A base of the transistor 32 is connected to the crystal oscillator 31. An emitter of the transistor 32 is grounded via a first resistor R1. A collector of the transistor 32 is connected to the diode cathode of the light-emitting diode 20. The crystal oscillator 31 is connected to the demodulating unit 70.

The light sensing unit 60 includes an opto-electronic coupler 61 and a second resistor R2. The opto-electronic coupler 61 includes a first coupler end and a second coupler end. The first coupler end of the opto-electronic coupler 61 is connected to the second voltage output pin V2. The second coupler end of the opto-electronic coupler 61 is connected to ground via the second resistor R2.

The demodulating unit 70 is connected between the second coupler end of the opto-electronic coupler 61 and the signal input pin I of the control chip 10.

The communication unit 40 is connected to the signal output pin O.

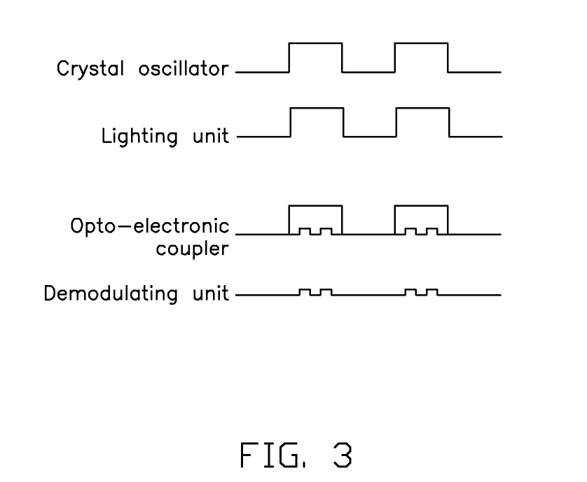

Referring to FIGS. 2 and 3, when the fan rotation speed detection system starts to work, the first voltage output pin V1 and the second voltage output pin V2 of the control pin 10 output voltages. The crystal oscillator 31 outputs a square wave signal, which is a sampling frequency signal. The transistor 32 is turned on when the square wave signal is at a high level. The transistor 32 is turned off when the square wave signal is at a low level. The light-emitting diode 20 emits light when the transistor 32 is on. The light-emitting diode 20 does not emit light when the transistor 32 is off.

The opto-electronic coupler 61 is aligned to the fan blades of the fan. The opto-electronic coupler 61 is turned on when the light-emitting diode 20 emits light and the fan blades reflect light to the opto-electronic coupler 61. A detection signal is transmitted from the opto-electronic coupler 61 to the demodulating unit 70 when the opto-electronic coupler 61 is on. The demodulating unit 70 receives the detection signal when the square wave signal is at a high level. The demodulating unit 70 demodulates the received detection signal to generate a demodulated signal. The demodulated signal is transmitted to the control chip 10 via the signal input pin I. The control chip 10 accounts a rotation speed of the fan according to the demodulated signal. Information about the rotation speed of the fan is transmitted to the computer 50. The computer 50 stores the information and displays the information on a screen of the computer 50.

In the fan rotation speed detection system, the demodulating unit 70 demodulates signals only when the square signal is at a high level, which lowers interference of environment light.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A fan rotation speed detection system, comprising:
a sampling and modulating unit configured to generate a sampling frequency signal, the sampling frequency signal being a square wave signal;
a lighting unit configured to emit light on fan blades of a fan when the square wave signal is at a high level;
a light sensing unit configured to sense light reflected from the fan blades and generate a detection signal;
a demodulating unit configured to demodulate the detection signal to generate a demodulated signal when the square wave signal is at a high level; and
a control chip configured to account a rotation speed of the fan according to the demodulated signal.

2. The fan rotation speed detection system of claim 1, wherein the control chip comprises a first voltage output pin, the lighting unit comprises a light-emitting diode, the first voltage output pin is connected to a diode anode of the light-emitting diode; the sampling and modulating unit comprises a crystal oscillator and a transistor, a diode cathode of the light-emitting diode is connected to ground via the transistor, the crystal oscillator outputs the square wave signal to control the transistor on or off.

3. The fan rotation speed detection system of claim 2, wherein a base of the transistor is connected to the crystal oscillator, an emitter of the transistor is connected to ground via a first resistor, and a collector of the transistor is connector to the diode cathode of the light-emitting diode.

4. The fan rotation speed detection system of claim 1, wherein the control chip comprises a second voltage output pin, the light sensing unit comprises an opto-electronic coupler, the opto-electronic coupler is connected to the second voltage output pin, and the opto-electronic coupler is configured to be turned on when the opto-electronic coupler senses the light reflected from the fan blades.

5. The fan rotation speed detection system of claim 4, wherein the opto-electronic coupler comprises a first coupler end and a second coupler end, the first coupler end of the opto-electronic coupler is connected to the second voltage output pin, and the second coupler end of the opto-electronic coupler is connected to ground via the second resistor.

6. The fan rotation speed detection system of claim 5, wherein the demodulating unit is connected between the emitter of the transistor and a signal input pin of the control chip.

7. The fan rotation speed detection system of claim 1, further comprising a computer connected to the control chip, wherein information about the rotation speed of the fan is transmitted to the computer, and the computer stores the information and displays the information on a screen of the computer.

8. A fan rotation speed detection system, comprising:
a sampling and modulating unit configured to generate a periodically sampling frequency signal;
a lighting unit connected to the sampling and modulating unit, the lighting unit configured to periodically emit light on fan blades of a fan according to the sampling frequency signal;
a light sensing unit in alignment with the fan blades of the fan, the light sensing unit configured to sense light reflected from the fan blades and generate a detection signal;
a demodulating unit connected to the light sensing unit, the demodulating unit configured to periodically receive and demodulate the detection signal to generate a demodulated signal according to the sampling frequency signal; and
a control chip configured to account a rotation speed of the fan according to the demodulated signal.

9. The fan rotation speed detection system of claim 8, wherein the sampling frequency signal is a square wave signal, the lighting unit emits light when the square wave signal is at a high level, and the demodulating unit receives and demodulates the detection signal when the square wave signal is at a high level.

10. The fan rotation speed detection system of claim 9, wherein the control chip comprises a first voltage output pin, the lighting unit comprises a light-emitting diode, the first voltage output pin is connected to a diode anode of the light-emitting diode; the sampling and modulating unit comprises a crystal oscillator and a transistor, a diode cathode of the light-emitting diode is connected to ground via the transistor, the crystal oscillator outputs the square wave signal to control the transistor on or off.

11. The fan rotation speed detection system of claim 10, wherein a base of the transistor is connected to the crystal oscillator, an emitter of the transistor is connected to ground via a first resistor, and a collector of the transistor is connector to the diode cathode of the light-emitting diode.

12. The fan rotation speed detection system of claim 8, wherein the control chip comprises a second voltage output pin, the light sensing unit comprises an opto-electronic coupler, the opto-electronic coupler is connected to the second voltage output pin, and the opto-electronic coupler is configured to be turned on when the opto-electronic coupler senses the reflected light from the fan blades.

13. The fan rotation speed detection system of claim 12, wherein the opto-electronic coupler comprises a first coupler end and a second coupler end, the first coupler end of the opto-electronic coupler is connected to the second voltage output pin, and the second coupler end of the opto-electronic coupler is connected to ground via the second resistor.

14. The fan rotation speed detection system of claim 13, wherein the demodulating unit is connected between the emitter of the transistor and a signal input pin of the control chip.

15. The fan rotation speed detection system of claim 8, further comprising a computer, connected to the control chip, wherein information about the rotation speed of the fan is transmitted to the computer, and the computer stores the information and displays the information on a screen of the computer.
